(19) United States
(12) Patent Application Publication
(10) Pub. No.: US 2010/0124938 A1
(43) Pub. Date: May 20, 2010

(54) Method and Related Apparatus for Managing Short Messages in a Mobile Communication System

(76) Inventor: Chien-Hsun Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/535,673

(22) Filed: Aug. 4, 2009

(30) Foreign Application Priority Data
Nov. 20, 2008 (TW) 097144892

(51) Int. Cl. H04W 4/12

(52) U.S. Cl. 455/466

(57) ABSTRACT

A method for managing short messages in a mobile communication system includes receiving a short message corresponding to a destination end, selecting a short message system corresponding to the destination end according to communication information of the destination end, transforming the short message according to a short message format of the short message system, and sending the transformed short message to the destination end via the short message system.

### BACKGROUND OF THE INVENTION

1. Field of the Invention

The present invention relates to a method and related apparatus for managing short messages in a mobile communication system, and more particularly, to a method and related apparatus for managing short messages and effectively reducing the cost of transnational short messages.

2. Description of the Prior Art

Along with the globalization concept unceasing development, more and more enterprises establish transnational organizations to reduce production cost, or provide customer transnational services. This kind of enterprise allocates bases around the world, so a way of contact with staffs is often a topic and many shortcomings need to be improved.

For example, short message transmission is an ideal approach comparing to other methods (such as telephone or e-mail, etc.) when enterprises release operating conditions or emergency notice to executives around the world. The reason is staffs may not be contacted immediately by telephone, which causes low efficiency and high mobile communication cost. In addition, although sending e-mail has advantages of high efficiency and low cost, staffs also may not be able to immediately contact. In comparison, a mobile phone is easy for carrying, so the method of sending transnational short messages can ensure staffs around the world can receive the short messages immediately, to transmit related information effectively.

However, if a large number of transnational short messages need to be sent in a short time, the transnational short messages need to be processed via systems of mobile communication companies around the world, but an operation method of each system is different, which causes inconvenience and delay. Also, the short messages sent by different mobile communication companies are difficult for management and evaluation, and are more difficult to estimate the cost of short messages transmission. In addition, the existing mobile short messages systems are usually sent in a great amount by manual input, which causes difficulty of automation and disadvantage usages and bridges of the existing information systems.

On the other hand, when staffs have business trips around the world, a way of utilizing mobile phone to roam can cause high cost. Therefore, the roaming is not suitable for a great deal of usage. If applying local phone numbers in all countries for contacting staffs, since the local phone numbers are involved multiple systems of mobile communication companies, which causes inconvenience of enterprise contacting staffs.

As can be seen from above, the method of short messages transmission needs to be improved in the prior art.

### SUMMARY OF THE INVENTION

Therefore, the present invention provides a method and related apparatus for managing short messages in a mobile communication system.

The present invention discloses a method for managing short messages in a mobile communication system, which includes receiving a short message corresponding to a destination end, selecting a short message system corresponding to the destination end according to communication information of the destination end, transforming the short message according to a short message format of the short message system, and sending the transformed short message to the destination end via the short message system.

The present invention discloses a device for managing short messages in a mobile communication system, which includes a reception unit for receiving a short message corresponding to a destination end, a selection unit for selecting a short message system corresponding to the destination end according to communication information of the destination end, a transformation unit for transforming the short message according to a short message format of the short message system, and a transmission unit for sending the transformed short message to the destination end via the short message system.

The present invention further discloses a mobile communication system for decreasing the cost of sending short messages, which includes a plurality of short message transmission ends, a plurality of destination ends, and a short message management device including a reception unit for receiving a short message corresponding to a destination end, a selection unit for selecting a short message system corresponding to the destination end according to communication information of the destination end, a transformation unit for transforming the short message according to a short message format of the short message system, and a transmission unit for sending the transformed short message to the destination end via the short message system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a mobile communication system according to an embodiment of the present invention.

FIG. 2 is a schematic diagram of a short message management device according to an exemplary embodiment of the present invention.

FIG. 3 is a flowchart diagram of a short message management according to an embodiment of the present invention.

### DETAILED DESCRIPTION

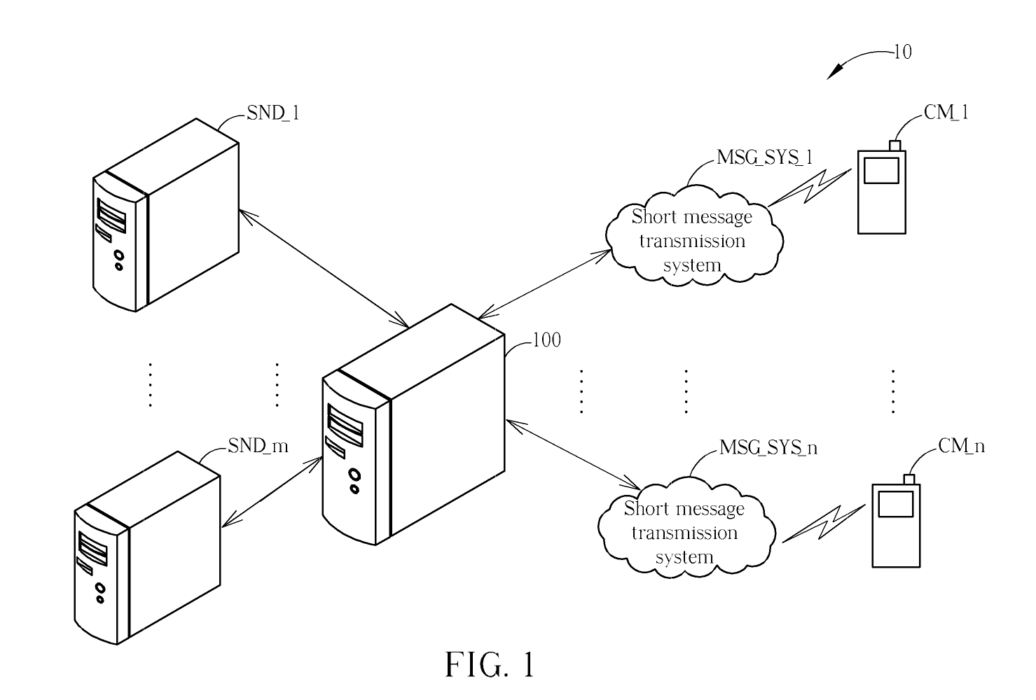

Please refer to FIG. 1, which is a schematic diagram of a mobile communication system 10 according to an embodiment of the present invention. The mobile communication system 10 includes short message transmission ends SND_1˜SND_m, destination ends CM_1˜CM_n, and a short message management device 100. The short message transmission ends SND_1˜SND_m are preferably a computer system, such as a laptop, desktop, PDA (Personal Digital Assistant), etc. The destination ends CM_1˜CM_n can be any communication devices for receiving short messages, such as a mobile phone, smart phone, etc, which are owned by staffs around the world of a transnational enterprise, and corresponding to short message transmission systems MSG_SYS_1˜MSG_SYS_n. When the short message transmission ends SND_1˜SND_m transmit a short message to one of the destination ends CM_1˜CM_n, the short message is transmitted to the short message management device 100, and then the short message management device 100 selects a proper short message transmission system according to related information, to transmit the short message to a corresponding destination end. The short message management device 100, the short message transmission ends SND_1˜SND_m, and the short message transmission systems MSG_SYS_1˜MSG_SYS_n are connected via internet.

In a word, when a short message transmission end SND_x transmits a short message MSG_SND to a destination end CM_y, the short message transmission end SND_x transmits the short message MSG_SND to the short message management device 100 via internet. Then, the short message management device 100 selects a short message transmission system MSG_SYS_y according to related information, transforms the short message MSG_SND to conform to rules and parameters of the short message transmission system MSG_SYS_y, and transmits the short message MSG_SND to the short message transmission system MSG_SYS_y via internet. Finally, the short message MSG_SND is transmitted to the destination end CM_y via the short message transmission system MSG_SYS_y. In other words, the short message management device 100 can automatically select a corresponding mobile communication company for transmitting short messages, to avoid the cost of roaming and save money. Meanwhile, since the short message management device 100 transforms short messages to a proper format, staffs operating the short message transmission ends SND_1˜SND_m just need to learn a system to transmit short messages worldwide.

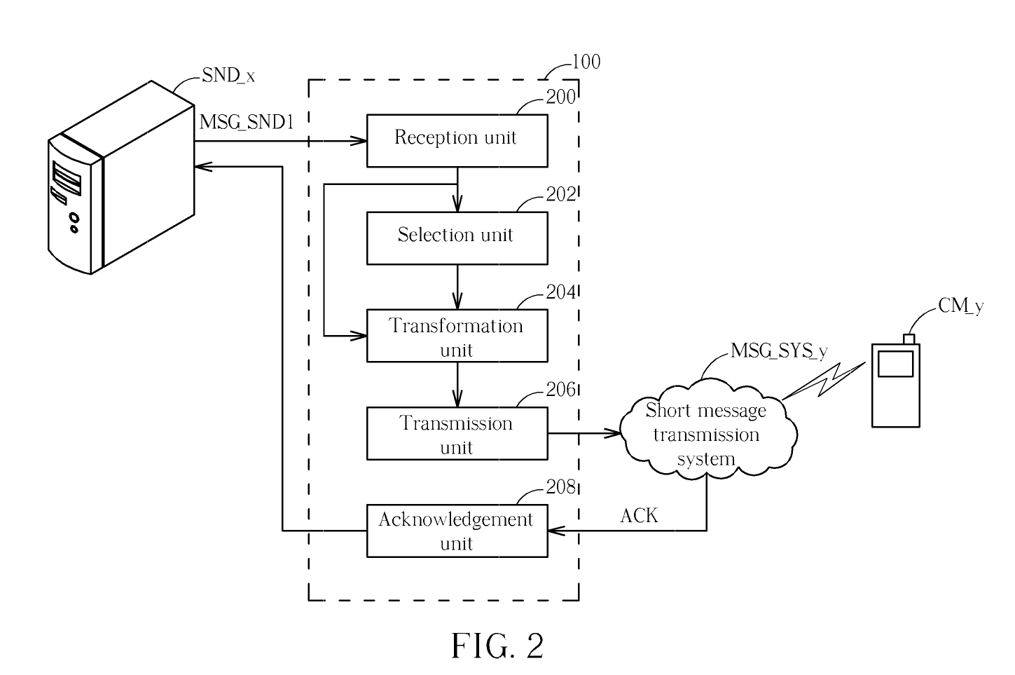

Please refer to FIG. 2, which is a schematic diagram of the short message management device 100 according to a preferred embodiment of the present invention. The short message management device 100 includes a reception unit 200, a selection unit 202, a transformation unit 204, a transmission unit 206, and an acknowledgement unit 208. The reception unit 200 is used for receiving the short message MSG_SND transmitted by the short message transmission end SND_x, and the short message MSG_SND is corresponding to the destination end CM_y. The selection unit 202 is used for selecting the corresponding short message system MSG_SYS_y according to communication information of the destination end CM_y. The transformation unit 204 is used for transforming the short message MSG_SND according to a short message format of the short message system MSG_SYS_y. The transmission unit 206 is used for sending the transformed short message MSG_SND to the destination end CM_y via the short message system MSG_SYS_y. In addition, the acknowledgement unit 208 is used for receiving an acknowledgement signal ACK sent by the short message system MSG_SYS_y, to determine whether the destination end CM_y receives the short message MSG_SND, and send related messages to the short message transmission end SND_x.

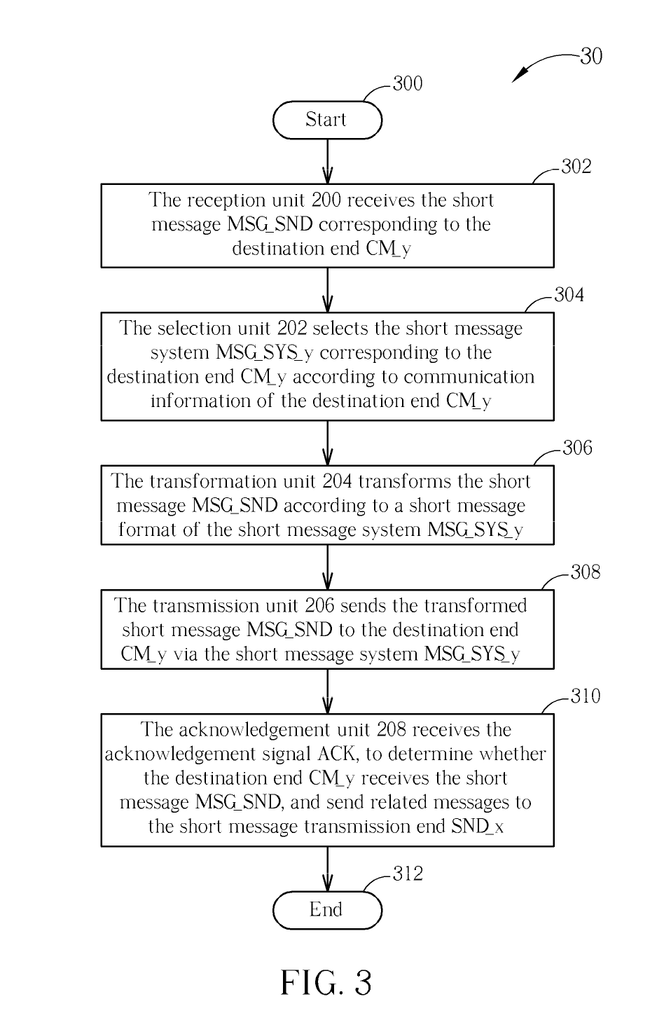

An operation method of the short message management device 100 can be concluded a message management process 30 shown in FIG. 3. The message management process 30 includes the following steps:

Step 300: Start.

Step 302: The reception unit 200 receives the short message MSG_SND corresponding to the destination end CM_y.

Step 304: The selection unit 202 selects the short message system MSG_SYS_y corresponding to the destination end CM_y according to communication information of the destination end CM_y.

Step 306: The transformation unit 204 transforms the short message MSG_SND according to a short message format of the short message system MSG_SYS_y.

Step 308: The transmission unit 206 sends the transformed short message MSG_SND to the destination end CM_y via the short message system MSG_SYS_y.

Step 310: The acknowledgement unit 208 receives the acknowledgement signal ACK, to determine whether the destination end CM_y receives the short message MSG_SND, and send related messages to the short message transmission end SND_x.

Step 312: End.

Therefore, when the short message transmission end SND_x transmits the short message MSG_SND to the destination end CM_y, the selection unit 202 can select the corresponding short message system MSG_SYS_y to transmit the short message MSG_SND, for avoiding the cost of roaming and saving production cost. Meanwhile, since the transformation unit 204 transforms short messages to a proper format, staffs operating the short message transmission ends SND_1˜SND_m just need to learn a system for transmitting short messages worldwide. Note that, the mobile communication system 10 shown in FIG. 1 is just a schematic diagram of an embodiment of the present invention, and those skilled in the art can make alternations and modifications accordingly. For example, the selection unit 202 selects the short message system MSG_SYS_y corresponding to the destination end CM_y according to the communication information of the destination end CM_y. The communication information of the destination end CM_y could be location information of the destination end CM_y (such as countries, areas, etc.), phone numbers, and identification information corresponding to the short message system MSG_SYS_y (such as a location of the short message system MSG_SYS_y, the cost of a short message, rules or parameters of short message transmission), etc. In addition, the short message MSG_SND is not limited to characters and could be a text message or a code corresponding to certain text content, which could be transmitted from an inner system, and the transformation unit 204 can transform the short message MSG_SND to text content accordingly.

In addition, the mobile communication system 10 receives or transmits short messages via internet, and staffs operating the short message transmission ends SND_1˜SND_m can generate or input short messages via browsing a certain webpage or executing a certain program. Moreover, if the mobile communication system 10 utilizes Open Internet Protocol (such as HTTP, XML, SOAP, etc), systems of different platforms utilizing different program languages can be integrated easily, so as to conquer integration difficulty of distribution system utilizing different systems.

As mentioned above, in the prior art, since the operation method of each system of mobile communication companies is different, transnational short messages are difficult to transmit in a short time and difficult for management, evaluation, and estimation of the cost. Meanwhile, the existing mobile short message systems are transmitted in a great amount by manual input, which causes difficulty of automation and disadvantage usages and bridges of the existing information systems. In comparison, the present invention automatically selects a corresponding mobile communication company for transmitting short messages, avoiding the cost of roaming, to reduce the cost. Meanwhile, since the short message management device 100 transforms short messages to a proper format, people operating the short message transmission ends SND_1˜SND_m just need to learn a system to transmit short messages worldwide. Moreover, the present invention can further provide a management method for record, determining which mobile communication company transmits short messages, and estimating communication cost. Furthermore, if a short message is failure to transmit, the management method will notify the manager to process immediately. In addition, the present invention receives or transmits short messages via internet, so systems of the enterprise can transmit short messages to staffs via the short message management device 100, to accomplish automation of messages transmission between systems.

Therefore, when a transnational enterprise wants to release operating conditions or emergency notice to staffs around the world, the method of short message transmission in the present invention can ensure staffs around the world can receive the short messages in time, and reduce the cost of transnational short messages.

In conclusion, the present invention can automatically select a proper mobile communication company for transmitting short messages and transform the short messages to proper formats. Therefore, the present invention can avoid the cost of roaming, to save money, and the staffs operating the short message transmission end just need to learn a system, to decrease the workload drastically.

Those skilled in the art will readily observe that numerous modifications and alterations of the device and method may be made while retaining the teachings of the invention.

What is claimed is:

1. A method for managing short messages in a mobile communication system comprising:
receiving a short message corresponding to a destination end;
selecting a short message system corresponding to the destination end according to a communication information of the destination end;
transforming the short message according to a short message format of the short message system; and
sending the transformed short message to the destination end via the short message system.

2. The method of claim 1, wherein receiving the short message corresponding to the destination end is receiving the short message corresponding to the destination end from a short message transmission end via internet.

3. The method of claim 1, wherein the communication information comprises a location information and a phone number of the destination end.

4. The method of claim 1, wherein the communication information comprises an identification information corresponding to the short message system of the destination end.

5. The method of claim 1, wherein the short message is a code corresponding to preset text content.

6. The method of claim 5, wherein transforming the short message according to the short message format of the short message system comprises transforming the code to the preset text content according to the short message format of the short message system.

7. The method of claim 1, wherein sending the transformed short message via the short message system is sending the transformed short message to the short message system via internet, to send the transformed short message via the short message system.

8. The method of claim 1 further comprising receiving an acknowledgement signal sent by the short message system, to determine whether the destination end receives the short message.

9. A device for managing short messages in a mobile communication system comprising:
a reception unit, for receiving a short message corresponding to a destination end;
a selection unit, for selecting a short message system corresponding to the destination end according to a communication information of the destination end;
a transformation unit, for transforming the short message according to a short message format of the short message system; and
a transmission unit, for sending the transformed short message to the destination end via the short message system.

10. The device of claim 9, wherein the reception unit receives the short message corresponding to the destination end from a short message transmission end via internet.

11. The device of claim 9, wherein the communication information comprises a location information and a phone number of the destination end.

12. The device of claim 9, wherein the communication information comprises an identification information corresponding to the short message system of the destination end.

13. The device of claim 9, wherein the short message is a code corresponding to preset text content.

14. The device of claim 13, wherein the transformation unit is utilized for transforming the code to the preset text content according to the short message format of the short message system.

15. The device of claim 9, wherein the transmission unit is utilized for sending the transformed short message to the short message system via internet, to send the transformed short message via the short message system.

16. The device of claim 9 further comprising an acknowledgement unit for receiving an acknowledgement signal sent by the short message system, to determine whether the destination end receives the short message.

17. A mobile communication system for decreasing the cost of sending short messages, comprising:
a plurality of short message transmission ends;
a plurality of destination ends; and
a short message management device comprising:
a reception unit, for receiving a short message corresponding to a destination end;
a selection unit, for selecting a short message system corresponding to the destination end according to a communication information of the destination end;
a transformation unit, for transforming the short message according to a short message format of the short message system; and
a transmission unit, for sending the transformed short message to the destination end via the short message system.

18. The short message management device of claim 17, wherein the short message transmission end sends the short message to the reception unit via internet.

19. The short message management device of claim 17, wherein the communication information comprises a location information and a phone number of the destination end.

20. The short message management device of claim 17, wherein the communication information comprises an identification information corresponding to the short message system of the destination end.

21. The short message management device of claim 17, wherein the short message is a code corresponding to preset text content.

22. The short message management device of claim 21, wherein the transformation unit is utilized for transforming the code to the preset text content according to the short message format of the short message system.

23. The short message management device of claim 17, wherein the transmission unit is utilized for sending the transformed short message to the short message system via internet, to send the transformed short message via the short message system.

24. The short message management device of claim 17 further comprising an acknowledgement unit for receiving an acknowledgement signal sent by the short message system, to determine whether the destination end receives the short message.
